(19) United States
(12) Patent Application Publication
(10) Pub. No.: US 2025/0367843 A1
(43) Pub. Date: Dec. 4, 2025

(54) CUTTING DEVICE, CUTTING SUPPORT METHOD, AND STORAGE MEDIUM

(71) Applicant: CASIO COMPUTER CO., LTD., Tokyo (JP)

(72) Inventor: Junji HOBO, Tokyo (JP)

(73) Assignee: CASIO COMPUTER CO., LTD., Tokyo (JP)

(21) Appl. No.: 19/197,809

(22) Filed: May 2, 2025

(30) Foreign Application Priority Data
Jun. 3, 2024 (JP) 2024-089611

(51) Int. Cl. B26D 5/00; B26D 1/04

(52) U.S. Cl. CPC B26D 5/005; B26D 1/04; B26D 2005/002

(57) ABSTRACT

A cutting device includes at least one processor that receives data in which an extended shape of a cutting line is set as a design, and in response to the design being an endless unicursal design that has a corner having an angle formed by two adjacent straight lines being a predetermined angle or greater and in which at least one of the straight lines is a specific straight line having a length set to a predetermined length or greater, sets a position on the specific straight line at least the predetermined length away from the corner along the specific straight line as a press-contact start position of a cutting member and sets the corner as a press-contact end position thereof to add at least the predetermined length to a length of one round of the cutting line for the cutting member to cut along the cutting line.

### CROSS-REFERENCE TO RELATED APPLICATIONS

This application is based upon and claims the benefit of priority under 35 USC 119 of Japanese Patent Application No. 2024-089611, filed on Jun. 3, 2024, the entire disclosure of which, including the description, claims, drawings, and abstract, is incorporated herein by reference in its entirety.

### TECHNICAL FIELD

The present disclosure relates to a cutting device, a cutting support method, and a storage medium.

### DESCRIPTION OF RELATED ART

There has been known a cutting device that performs a desired cutting process on an object to be cut (cutting target) by moving a cutter blade and the object relatively to one another. For example, in JP 2012-206234 A, there is disclosed that in a case where a cutting device cuts out, from an object to be cut (cutting target), a closed shape having a cutting start point and a cutting end point that coincide with one another, if the cutting start point and the cutting end point are at a specific position on a cutting line (e.g., intersection of sides of a polygon), the position(s) of the cutting start point and the cutting end point are changed to, on the cutting line, a position(s) other than the specific position, so that the object is not cut excessively and also an uncut part is not left.

### SUMMARY OF THE INVENTION

According to an aspect of the present disclosure, there is provided a cutting device including:
a cutting member; and
at least one processor that
   receives an input of data in which an extended shape of a cutting line is set as a design, and
   in response to the design in the data being an endless unicursal design that has a corner having an angle formed by two straight lines adjacent to one another being a predetermined angle or greater and in which at least one of the two straight lines forming the corner is a specific straight line having a length set to a predetermined length or greater, sets a position on the specific straight line at least the predetermined length away from the corner along the specific straight line as a press-contact start position of the cutting member and sets the corner as a press-contact end position of the cutting member to add at least the predetermined length to a length of one round of the cutting line for the cutting member to cut along the cutting line.

### BRIEF DESCRIPTION OF DRAWINGS

FIG. 1 is a block diagram illustrating a cutting system according to an embodiment(s) of the present disclosure.

FIG. 2 is a perspective view illustrating the overall configuration of a cutting device.

FIG. 3 is a side view of a carriage that holds a cutter unit disposed in the cutting device.

FIG. 4 is a plan view of a mount.

FIG. 5 is a block diagram illustrating a functional configuration of the cutting device.

FIG. 6 is a block diagram illustrating a functional configuration of a terminal device.

FIG. 7 is an illustration to explain an offset distance of a cutter blade.

FIG. 8 is a flowchart illustrating a control procedure for a cutting support process.

FIG. 9A is an illustration to explain settings of a press-contact start position and a press-contact end position of the cutter blade.

FIG. 9B illustrates an example of a cut form made by the cutting device of the embodiment performing cutting based on a predetermined cutout design.

FIG. 9C illustrates an example of a cut form made by the cutting device of the embodiment performing cutting based on the predetermined cutout design.

FIG. 10A illustrates an example of a cut form made by a conventional cutting device performing cutting based on a predetermined cutout design.

FIG. 10B illustrates an example of a cutting form made by the conventional cutting device performing cutting based on the predetermined cutout design.

### DETAILED DESCRIPTION

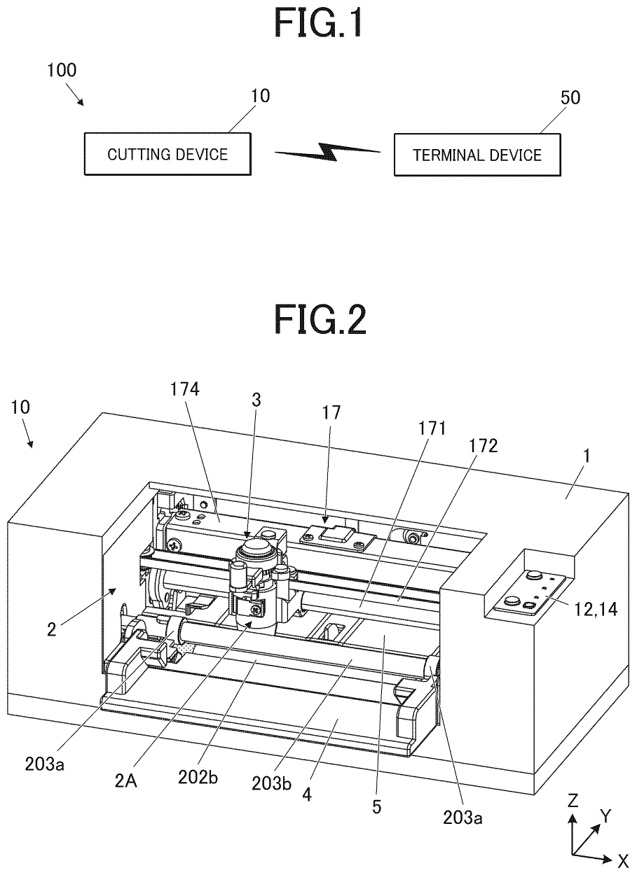

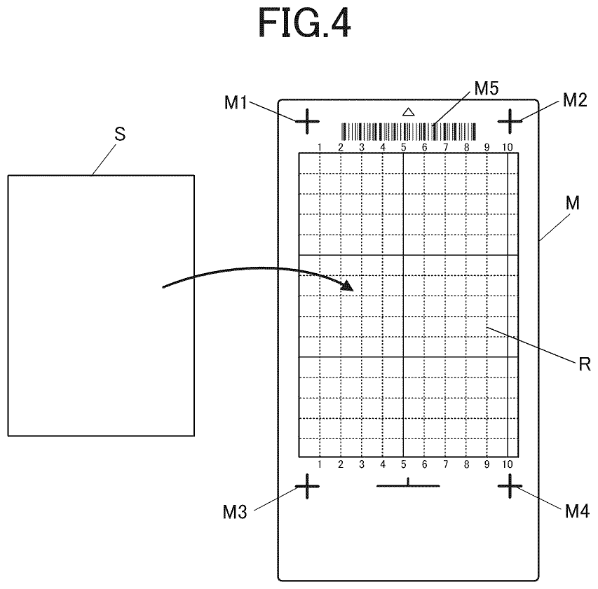

Hereinafter, one or more embodiments of the present disclosure will be described in detail with reference to the drawings. However, the scope of the present disclosure is not limited to the illustrated examples. As illustrated in FIG. 1, a cutting system 100 of an embodiment(s) includes a cutting device 10 and a terminal device 50. The cutting device 10 is a device that cuts a planar cutting target S, for example, a rectangular cutting target S, attached to a mount M (in FIG. 4) placed (set) on a placement plate 5 (described later) into any planar shape. In this embodiment, the cutting target S is a sheet of paper, but not limited thereto. The cutting target S may be another medium that can be cut with/by a cutter blade, such as a resin sheet, a sticker (seal) or leather.

The terminal device 50 is a smartphone that generates/edits cutting data indicating a planar shape, a position and so forth for the cutting device 10 to perform cutting. In addition to this, the terminal device 50 receives inputs of operation information related to the cutting device 10, displays display information related to the cutting device 10, and so forth. The terminal device 50 is used in a state of being communicatively connected with the cutting device 10 by wireless communication. The terminal device 50 communicatively connected with the cutting device 10 is not limited to a smartphone, but may be another terminal device, such as a personal computer (PC) or a tablet terminal. In this embodiment, the communication method of the wireless communication between the cutting device 10 and the terminal device 50 is Bluetooth®, but not limited thereto. The communication method of the wireless communication may be another communication method, such as Wi-Fi®. The communication connection between the cutting device 10 and the terminal device 50 is not limited to wireless communication, but may be wired communication. The wired communication is, for example, a universal serial bus (USB) communication via a communication cable.

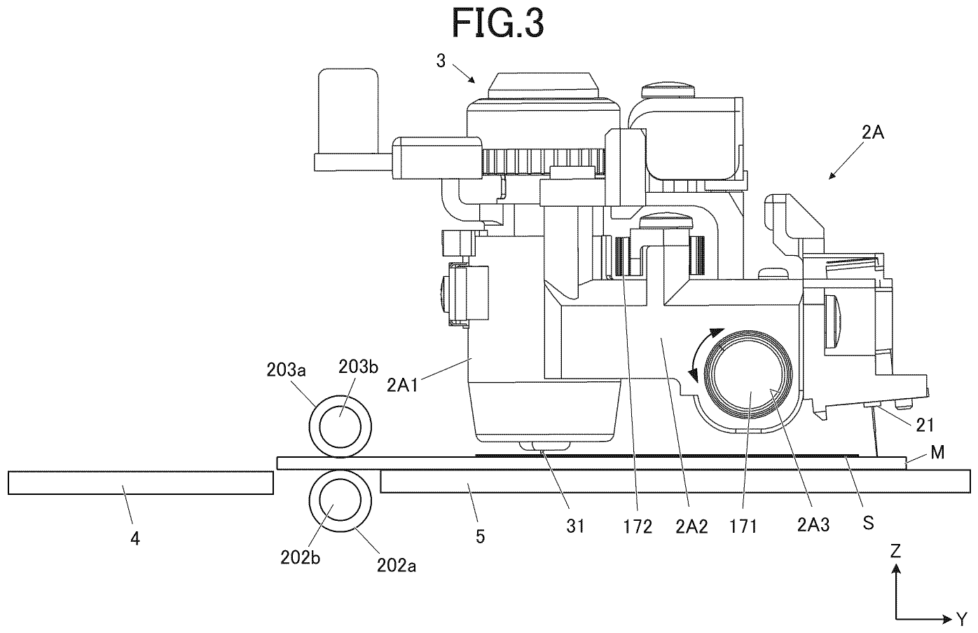

As illustrated in FIG. 2, the cutting device 10 extends along the X-axis. The direction along the X-axis corresponds to the device's right-left direction (width direction). The direction along the Y-axis is the device's front-back direction (depth direction). The Z-axis is perpendicular to the XY plane, and is parallel to a direction in which a cutter blade 31 (described later) moves up and down with respect to the cutting target S. The direction along the Z-axis is the device's height direction. The cutting device 10 includes a case 1 and a body 2 stored in the case 1. At the device's front side on the bottom surface of the case 1, a sheet feed plate 4 from which the mount M with the cutting target S attached is fed is disposed, and at the device's deep/back side on the bottom surface of the case 1, the aforementioned placement plate 5 on which the mount M is placed during cutting is disposed, as illustrated in FIG. 3. Between the sheet feed plate 4 and the placement plate 5, a pair of driving rollers 202a and a pair of driven rollers 203a corresponding to the pair of driving rollers 202a are disposed to be aligned in the Z-axis direction (up-down direction), as illustrated in FIG. 3. The driving rollers 202a are at the lower side, and the driven rollers 203a are at the upper side. The driving rollers 202a are attached to a rotation shaft 202b in a state in which a predetermined gap is provided between the driving rollers 202a. This predetermined gap is a distance that allows the ends of the mount M in the width direction (X-axis direction) to be sandwiched between the driving rollers 202a and the driven rollers 203a. The driven rollers 203a are attached to a rotation shaft 203b in a state in which the aforementioned predetermined gap is provided between the driven rollers 203a. If the mount M is fed to the sheet feed plate 4, both ends of the leading edge of the mount M are sandwiched between the driving rollers 202a and the driven rollers 203a.

The case 1 is box-shaped, and an operation receiver 12 (described later) and an indicator 14 (described later) are set, for example, on the outer side of the upper surface of the case 1. The body 2 includes a carriage 2A that holds a cutter unit 3 including a cutter blade 31 (cutting member) and a driver 17 that moves the cutter unit 3 by moving the carriage 2A holding the cutter unit 3. As illustrated in FIG. 3, the carriage 2A includes a holding part 2A1 that holds the cutter unit 3 inside and a connecting part 2A2 that is disposed continuously with the holding part 2A1. The holding part 2A1 holds the cutter unit 3 detachably. For example, if the cutter blade 31 has worn away and accordingly is replaced, the cutter unit 3, which includes the cutter blade 31, is removed from the carriage 2A and replaced. The connecting part 2A2 is provided with a through hole 2A3 that penetrates in the X-axis direction. Into this through hole 2A3, a shaft 171 of the driver 17 is inserted. Around (part of) the connecting part 2A2, a timing belt 172 is wound, and in response to the timing belt 172 operating by the drive of an X-axis motor (drive motor in the X-axis direction) 173 of the driver 17, the carriage 2A can move in the X-axis direction along the shaft 171. In this embodiment, the shaft 171, the timing belt 172, the X-axis motor 173 and so forth constitute an X-axis direction drive mechanism. The driver 17 also includes a Z-axis direction drive mechanism 174 that is capable of adjusting the position (height position) of the cutter blade 31 in the Z-axis direction. The Z-axis direction drive mechanism 174 includes a Z-axis motor (drive motor in the Z-axis direction) 175. In this embodiment, for example, the Z-axis motor 175 is driven to rotate the entire carriage 2A about the shaft 171 (indicated by a double arrow in FIG. 3) as a rotation axis.

Thus, the carriage 2A is movable along the X-axis direction (device's width direction or left-right direction) by the drive of the X-axis motor 173, and also movable along the Z-axis direction (device's height direction or up-down direction) by the drive of the Z-axis motor 175. The mount M with the cutting target S attached fed to the sheet feed plate 4 can be brought onto the placement plate 5 by the driving rollers 202a rotating by the drive of a Y-axis motor (drive motor in the Y-axis direction) 201 of a sheet feeder 20 (described later). The mount M brought onto the placement plate 5 is movable along the Y-axis direction (device's depth direction or front-back direction) by the driving rollers 202a keeping rotating by the drive of the Y-axis motor 201. Thus, during cutting, the cutter blade 31 of the cutter unit 3 held by the carriage 2A moves in the X-axis direction (right-left direction) as appropriate and the cutting target S moves in the Y-axis direction (front-back direction), so that the cutter blade 31 can cut the cutting target S into a specified shape. That is, the cutter blade 31 can cut the cutting target S into a specified shape by the positions of the cutter blade 31 and the cutting target S relative to one another being changed with the cutter blade 31 pressed against the cutting target S.

Hereinafter, the mount M will be described with reference to FIG. 4. The mount M is used, for example, to prevent the cutter blade 31 from damaging the placement plate 5 and to place the cutting target S at a correct position. As illustrated in FIG. 4, the mount M is planar and rectangular. The mount M is made of, for example, polycarbonate. The mount M has, on the upper surface, a grid region R where a grid is printed. To this grid region R, an adhesive for attaching the cutting target S is applied. The mount M has a barcode M5 printed above the grid region R. The barcode M5 is a barcode for determining that the mount M dedicated to the cutting device 10 is placed on the placement plate 5, and can be read by a sheet feeding detector 21 (described later). That is, the sheet feeding detector 21 reading the barcode M5 means that the mount M dedicated to the cutting device 10 is placed on the placement plate 5. The mount M also has a first position-detection marker M1 printed on the left of the barcode M5 and a second position-detection marker M2 printed on the right of the barcode M5. The mount M also has a third position-detection marker M3 printed under the lower left corner of the grid region R and a fourth position-detection marker M4 printed under the lower right corner of the grid region R. That is, the first to fourth position-detection markers M1 to M4 are all printed outside the grid region R and exposed from the cutting target S attached to the grid region R. The first to fourth position-detection markers M1 to M4 are markers for detecting occurrence of conveyance deviation of the mount M due to cutting and each have a cross shape. The first to fourth position-detection markers M1 to M4 are all readable by the sheet feeding detector 21, as with the barcode M5.

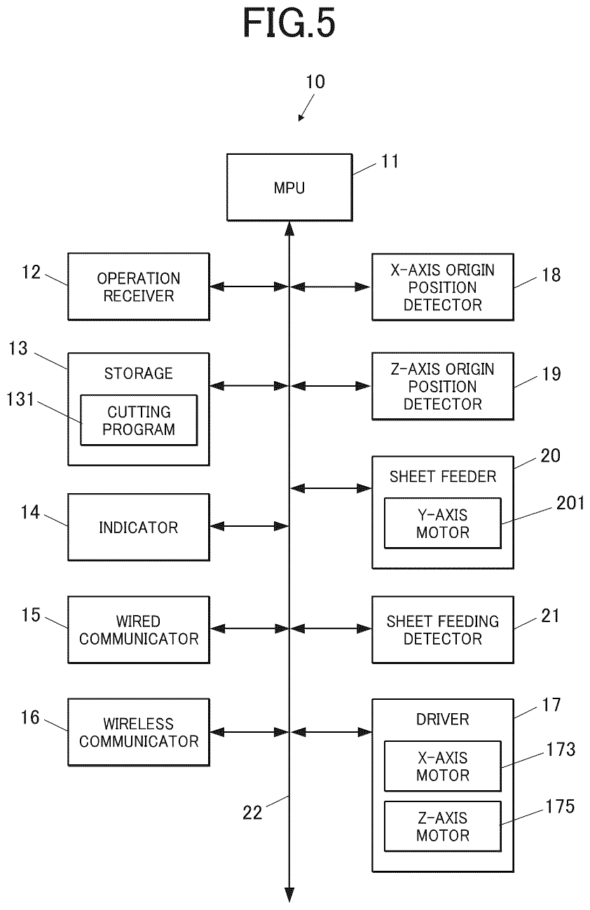

Next, a functional configuration of the cutting device 10 will be described. As illustrated in FIG. 5, the cutting device 10 includes a micro processor unit (MPU) 11 as a controller (processor), the aforementioned operation receiver 12, a storage 13, the aforementioned indicator 14, a wired communicator 15, a wireless communicator 16, the aforementioned driver 17, an X-axis origin position detector 18, a Z-axis origin position detector 19, the aforementioned sheet feeder 20, and the aforementioned sheet feeding detector 21. These components of the cutting device 10 are connected with one another via a bus 22.

The MPU 11 controls the components of the cutting device 10. The MPU 11 includes a central processing unit (CPU) and a random access memory (RAM). The CPU reads a specified program among various programs stored in the storage 13, loads the specified program to the RAM, and performs a process among various processes in cooperation with the loaded program. The RAM is a volatile semiconductor memory and forms a work area where various data and programs are stored temporarily. The operation receiver 12 has various buttons, and receives press inputs made by a user onto the buttons and outputs pieces of operation information corresponding to the inputs to the MPU 11. The various buttons of the operation receiver 12 include a button to pause cutting and a button to remove the mount M.

The storage 13 is an information readable- and writable storage, such as a flash memory. The storage 13 stores various data, such as the aforementioned cutting data, and various programs. The storage 13 stores a cutting program(s) 131 to perform a cutting process and a cutting support process. The indicator 14 includes a light emitter, such as a light emitting diode (LED), and indicates various states of the cutting device 10 by lighting and no-lighting. The indicator 14 also includes, for example, a power lamp that indicates power-on and power-off. The indicator 14 causes the light emitter to emit light or not to emit light in accordance with an instruction from the MPU 11.

The wired communicator 15 is an interface for wired communication conforming to a communication standard such as USB. The MPU 11 transmits and receives information to and from external devices, such as the terminal device 50, via the wired communicator 15 and a communication cable. The wireless communicator 16 includes an antenna, a modulation-and-demodulation circuit and a signal processing circuit, and is an interface for Bluetooth communication with external devices, such as the terminal device 50. The MPU 11 transmits and receives information to and from external devices, such as the terminal device 50, via the wireless communicator 16.

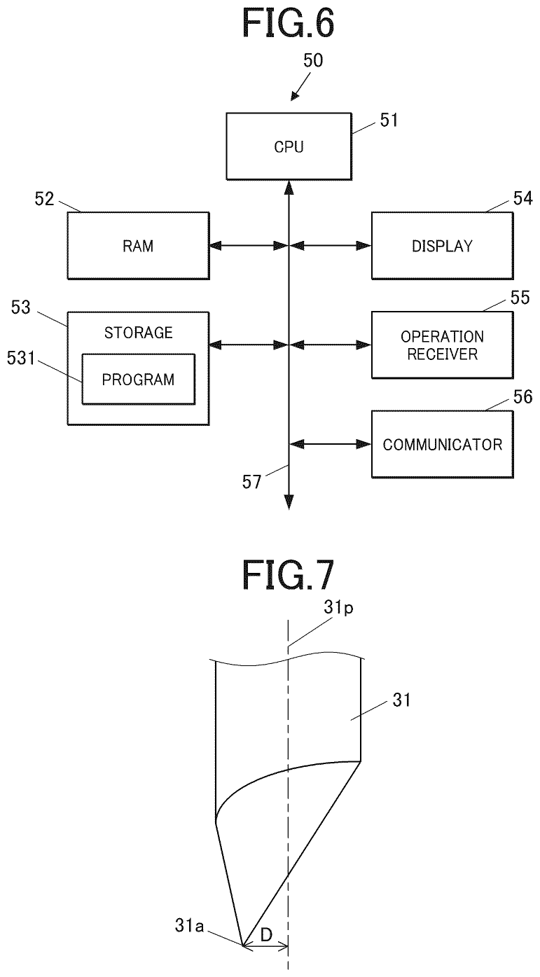

The driver 17 moves the cutter blade 31 of the cutter unit 3 held by the carriage 2A in the X-axis direction and the Z-axis direction by driving the X-axis motor 173 and the Z-axis motor 175 in accordance with instructions from the MPU 11. By moving the cutter blade 31, the driver 17 causes the cutter blade 31 to cut the cutting target S attached to the mount M placed on the placement plate 5 into any planer shape. The cutter blade 31 is disposed in (mounted on) the cutter unit 3 in a state in which the cutter blade 31 is freely rotatable on an axis (drive axis) 31p (in FIG. 7). That is, the edge 31a (in FIG. 7) of the cutter blade 31 is designed to face a cutting direction so that the cutting target S is cut. The edge (edge 31a) of the cutter blade 31 can be made to face a desired direction (e.g., cutting direction) by the carriage 2A being moved in the X-axis direction or the mount M with the cutting target S attached being moved (conveyed) in the Y-axis direction in a state in which the edge 31a of the cutter blade 31 is pressed against the cutting target S.

The X-axis origin position detector 18 is a position detector, such as an optical sensor, that detects in accordance with an instruction from the MPU 11 whether the carriage 2A is at the position of the origin in the X-axis direction. The X-axis origin position detector 18 outputs the detection result of whether the carriage 2A is at the position of the origin in the X-axis direction to the MPU 11. The MPU 11 controls the position of the cutter blade 31 in the X-axis direction, using the detection result of whether the carriage 2A is at the position of the origin in the X-axis direction. The Z-axis origin position detector 19 is a position detector, such as an optical sensor, that detects in accordance with an instruction from the MPU 11 whether the carriage 2A is at the position of the origin in the Z-axis direction. The Z-axis origin position detector 19 outputs the detection result of whether the carriage 2A is at the position of the origin in the Z-axis direction to the MPU 11. The MPU 11 controls the position of the cutter blade 31 in the Z-axis direction, using the detection result of whether the carriage 2A is at the position of the origin in the Z-axis direction.

The sheet feeder 20 is a conveyor that conveys, in the Y-axis direction, the mount M to which the cutting target S is attached and that is sandwiched between the driving rollers 202a and the driven rollers 203a, by rotating the driving rollers 202a by the drive of the Y-axis motor 201 in accordance with an instruction from the MPU 11. The sheet feeding detector 21 is a detector, such as an optical sensor, that is capable of detecting, in accordance with an instruction from the MPU 11, the leading edge of the mount M placed on the placement plate 5. The sheet feeding detector 21 is also capable of reading, in accordance with an instruction from the MPU 11, the barcode M5 (in FIG. 4) printed on the mount M. The sheet feeding detector 21 is also capable of detecting, in accordance with an instruction from the MPU 11, the first to fourth position-detection markers M1 to M4 (in FIG. 4). The sheet feeding detector 21 outputs, to the MPU 11, the detection result of the leading edge of the mount M, the reading result of the barcode M5, and the detection results of the first to fourth position-detection markers M1 to M4. The sheet feeding detector 21 is disposed on the connecting part 2A2 (in FIG. 3) of the carriage 2A. That is, the sheet feeding detector 21 is disposed to move together with the cutter blade 31 with respect to the mount M (cutting target S), at least in the X-axis direction. More specifically, the sheet feeding detector 21 is disposed on the lower surface of the connecting part 2A2, namely, on the surface facing the upper surface of the mount M.

Next, a functional configuration of the terminal device 50 will be described. As illustrated in FIG. 6, the terminal device 50 includes a CPU 51, a RAM 52, a storage 53, a display 54, an operation receiver 55, and a communicator 56. These components of the terminal device 50 are connected with one another via a bus 57. The CPU 51 is a processor that reads and executes programs 531 stored in the storage 53 to perform various types of arithmetic processing, thereby controlling operation of each component of the terminal device 50. The RAM 52 provides a working memory space for the CPU 51 and stores temporary data. The storage 53 is a non-transitory storage medium readable by the CPU 51 as a computer, and stores the programs 531 and various data (e.g., cutting data).

The display 54 is configured by a liquid crystal display (LCD), an electro luminescence (EL) display or the like, and performs various types of display in accordance with pieces of display information (display instructions) from the CPU 51. The operation receiver 55 includes a power button (not illustrated), a home button (not illustrated), and a touch sensor (not illustrated) provided on the display 54, and receives inputs of operations made by a user and outputs pieces of operation information corresponding to the inputs to the CPU 51. The CPU 51 receives the inputs of the operations made by the user on the basis of the pieces of operation information transmitted from the operation receiver 55. The communicator 56 is, for example, a communicator employing a wireless standard, such as Bluetooth, or a wired communicator, such as a USB terminal.

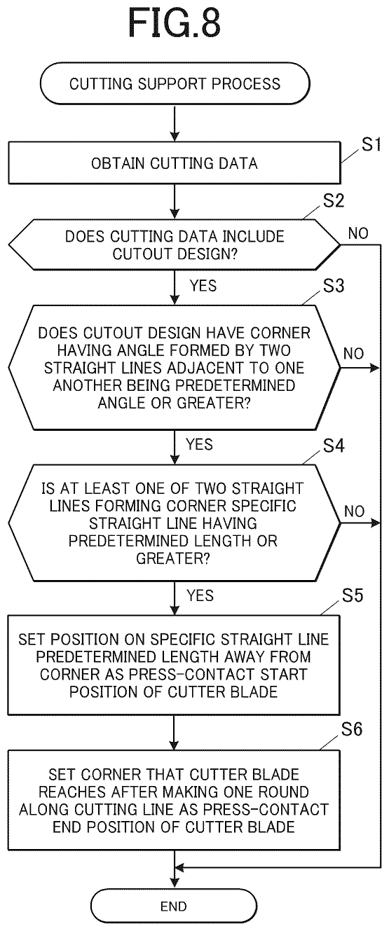

Next, the cutting support process that is performed by the cutting device 10 will be described with reference to FIG. 8. The cutting support process is roughly a process of, in response to determining that a cutout design satisfies a predetermined condition (YES in Step S3 and YES in Step S4 described below), setting, as a press-contact start position of the cutter blade 31, a position on a predetermined straight line (specific straight line) a predetermined length away from a corner and setting, as a press-contact end position of the cutter blade 31, the corner that the cutter blade 31 reaches after making one round along a cutting line to add the predetermined length to the length of one round of the cutting line. The cutting device 10 starts the cutting support process, for example, in response to receiving cutting start request data for the cutting process from the terminal device 50 via the wireless communicator 16. This cutting start request data is provided with cutting data (design data) indicating a planar shape (extended shape of a cutting line), a position and so forth to cut the cutting target S.

As illustrated in FIG. 8, in response to the start of the cutting support process, the MPU 11 of the cutting device 10 first obtains the cutting data attached to the cutting start request data (Step S1). It means that the MPU 11 receives an input of cutting data in which an extended shape of a cutting line is set as a design. Next, the MPU 11 determines whether the cutting data obtained in Step S1 includes a cutout design (Step S2). The cutout design means a design of an extended shape of a cutting line having no end, namely, an endless unicursal design of a quadrilateral shape, a triangular shape or the like.

In Step S2, if the MPU 11 determines that the cutting data does not include a cutout design (Step S2; NO), the MPU 11 ends the cutting support process. That is, if a cutting design is a design of an extended shape of a cutting line having ends, such as a V-shape or a U-shape, cutting is performed using the original cutting data in which one of the ends is set as the press-contact start position of the cutter blade and the other thereof is set as the press-contact end position of the cutter blade. In Step S2, if the MPU 11 determines that the cutting data includes a cutout design (Step S2; YES), the MPU 11 determines whether the cutout design is a design having a corner having an angle formed by two straight lines adjacent to one another being a predetermined angle (e.g., 45 degrees) or greater (Step S3). If the cutting data includes two or more cutout designs, the MPU 11 performs the processes of Step S3 and the following steps for each of the cutout designs. The aforementioned predetermined angle can be set/changed as appropriate.

In Step S3, if the MPU 11 determines that the cutout design is not a design having a corner having an angle formed by two straight lines adjacent to one another being the predetermined angle or greater (Step S3; NO), the MPU 11 sets, for the cutout design, a position on a cutting line as the press-contact start position and the press-contact end position of the cutter blade 31 to make the press-contact start position and the press-contact end position coincide with one another, and ends the cutting support process. In Step S3, if the MPU 11 determines that the cutout design is a design having a corner having an angle formed by two straight lines adjacent to one another being the predetermined angle or greater (Step S3; YES), the MPU 11 determines whether at least one of the two straight lines forming the corner is a specific straight line having a length set to a predetermined length L, which will be described later, or greater (Step S4). The predetermined length L is preferably a length longer than an offset distance D from the axis 31p (predetermined axis) of the cutter blade 31 to the edge 31a of the cutter blade 31 illustrated in FIG. 7. The cutter blade 31 is disposed in the cutter unit 3 in the state in which the cutter blade 31 is freely rotatable on the axis 31p.

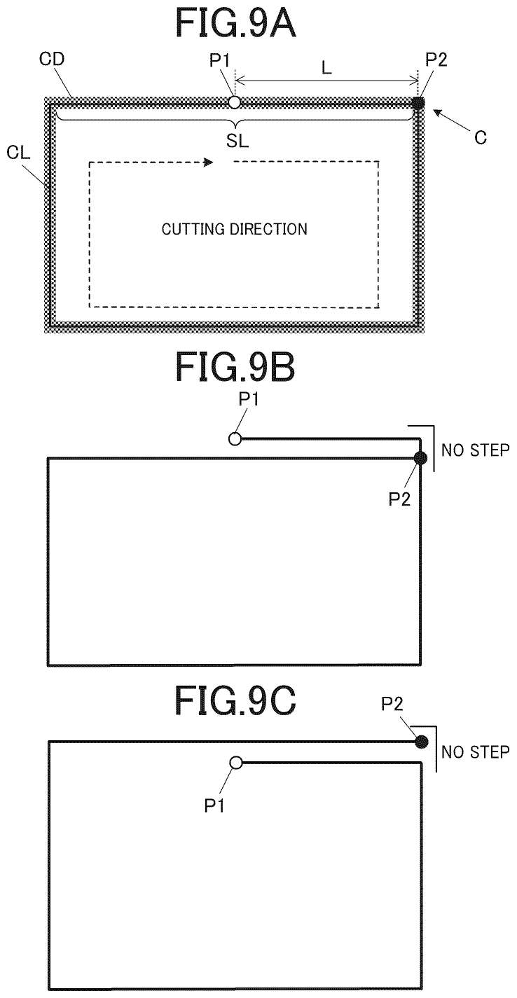

In Step S4, if the MPU 11 determines that not at least one of the two straight lines forming the corner is a specific straight line having a length set to the predetermined length L or greater (Step S4; NO), the MPU 11 sets, for the cutout design, about which the determination was made in Step S4, a position on a cutting line as the press-contact start position and the press-contact end position of the cutter blade 31 to make the press-contact start position and the press-contact end position coincide with one another, and ends the cutting support process. In Step S4, if the MPU 11 determines that at least one of the two straight lines forming the corner is a specific straight line having a length set to the predetermined length L or greater (Step S4; YES), the MPU 11 sets a position on the specific straight line the predetermined length L away from the corner as the press-contact start position of the cutter blade 31 (Step S5). More specifically, as illustrated in FIG. 9A, if a cutting design CD included in the cutting data received by the MPU 11 is a cutout design (Step S2; YES), has a corner C having an angle formed by two straight lines adjacent to one another being the predetermined angle or greater (Step S3; YES), and is a design in which at least one of the two straight lines forming the corner C is a specific straight line SL having a length set to the predetermined length L or greater, the MPU 11 sets a position on the specific straight line SL the predetermined length L away from the corner C along the specific straight line SL as a press-contact start position P1 of the cutter blade 31 to add the predetermined length L to the length of one round of the cutting line CL for the cutter blade 31 to cut along the cutting line CL. The predetermined length L is preset to a length equal to or greater than a length corresponding to the aforementioned offset distance D (in FIG. 7) of the cutter blade 31. The predetermined length L may be a length corresponding to the offset distance D of the cutter blade 31. The predetermined length L may be changed depending on the cutting design CD to be the same as the length of the specific straight line SL, provided that the predetermined length L is equal to or greater than the length corresponding to the offset distance D.

Next, the MPU 11 sets the corner as the press-contact end position of the cutter blade 31 (Step S6). More specifically, as illustrated in FIG. 9B, the MPU 11 sets, as a press-contact end position P2 of the cutter blade 31, the corner C (the first corner in the second round) that the cutter blade 31 reaches after making one round along the cutting line CL from the press-contact start position P1 of the cutter blade 31 set in Step S5. That is, the cutting line CL between the press-contact start position P1 and the press-contact end position P2 on the specific straight line SL is cut twice by the cutter blade 31. Then, the MPU 11 ends the cutting support process. In the case where the cutting device 10 of this embodiment performs the cutting process on the basis of a cutout design, the cutting device 10 performs the cutting process on the basis of the press-contact start position and the press-contact end position of the cutter blade 31 set in the above-described cutting support process. The cutter blade 31 of the cutter unit 3 held by the carriage 2A is moved in the Z-axis direction (up-down direction) at the press-contact start position and the press-contact end position of the cutter blade 31 by the drive of the Z-axis motor 175, thereby starting and ending (being released from) being pressed against the cutting target S, respectively.

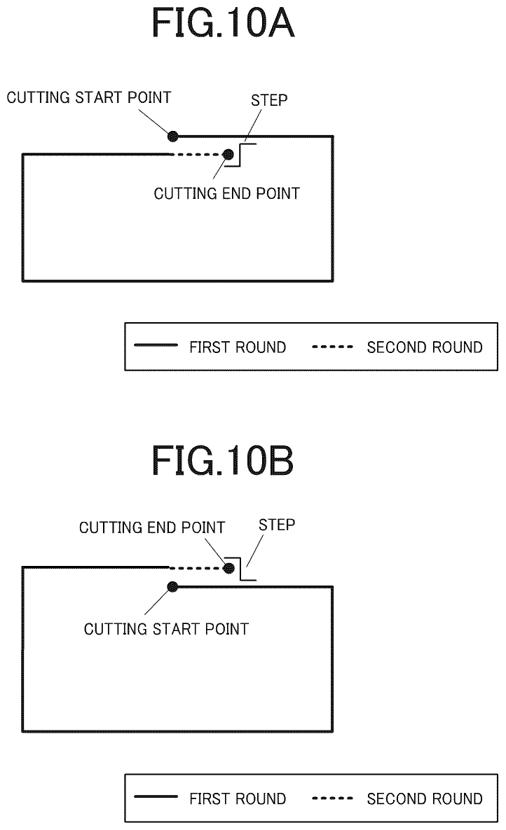

As described above, the MPU 11 of the cutting device 10 receives an input of cutting data in which an extended shape of a cutting line CL is set as a cutting design CD, and in response to the cutting design CD in the data being a cutout design (endless unicursal design) that has a corner C having an angle formed by two straight lines adjacent to one another being a predetermined angle or greater and in which at least one of the two straight lines forming the corner C is a specific straight line SL having a length set to a predetermined length or greater, sets a position on the specific straight line SL at least the predetermined length away from the corner C along the specific straight line SL as a press-contact start position P1 of the cutter blade 31 and sets the corner C as a press-contact end position P2 of the cutter blade 31 to add at least the predetermined length to a length of one round of the cutting line CL for the cutter blade 31 to cut along the cutting line CL, as illustrated in FIG. 9A. Thus, according to the cutting device 10, the corner C that the cutter blade 31 reaches after making one round along the cutting line CL from the press-contact start position P1 of the cutter blade 31 is set as the press-contact end position P2 of the cutter blade 31. Therefore, as illustrated in FIG. 9B and FIG. 9C, even if the trajectory of the cutter blade 31 is unstable and deviates while the cutter blade 31 is cutting along the cutting line CL, a step (in FIG. 10A and FIG. 10B) is not generated in the middle of the specific straight line SL where the press-contact start position P1 and the press-contact end position P2 of the cutter blade 31 are set. Thus, according to the cutting device 10, in the case of cutting based on a predetermined cutout design (cutting design CD in FIG. 9A), the cutting device 10 has no difficulty in cutting-out and does not create a poor-looking cutout.

Although in the above, the present disclosure has been described on the basis of one or more embodiments, the present disclosure is not limited to the above-described embodiments and can be modified without departing from the scope of the present disclosure.

For example, in the above embodiment(s), the cutter blade 31 starts or ends (is released from) being pressed against the cutting target S by the cutter blade 31 of the cutter unit 3 held by the carriage 2A being moved in the Z-axis direction (up-down direction) by the drive of the Z-axis motor 175. However, the cutter blade 31 may start or end (be released from) being pressed against the cutting target S, for example, by the placement plate 5 being configured to be movable in the Z-axis direction and the placement plate 5 on which the mount M with the cutting target S attached is placed being moved in the Z-axis direction.

Furthermore, if the region outside the region (cutout region) closed by the cutting line CL (in FIG. 9A) is an unnecessary region in the above embodiment(s), a position on a line segment extending from the specific straight line SL beyond the corner C may be set as the press-contact end position P2 of the cutter blade 31.

Furthermore, in the cutting support process (in FIG. 8) of the above embodiment(s), if the MPU 11 determines “NO” in Step S3 or Step S4, the MPU 11 sets, for the cutout design, about which the determination was made in Step S3 or Step S4, a position on a cutting line as the press-contact start position and the press-contact end position of the cutter blade 31 to make the press-contact start position and the press-contact end position of the cutter blade 31 coincide with one another, but the press-contact end position of the cutter blade 31 does not need to coincide with the press-contact start position of the cutter blade 31. In this case, for example, a position on the cutting line in the second round that the cutter blade 31 reaches after making one round (first round) along the cutting line from the press-contact start position may be set as the press-contact end position of the cutter blade 31.

Furthermore, in the above embodiment(s), the computer-readable medium storing the program(s) according to the present disclosure is a flash memory or the like, but not limited thereto. The computer-readable medium may be a portable recording/storage medium, such as a CD-ROM. Furthermore, carrier waves are also applied to the present disclosure as a medium that provides data of the program(s) according to the present disclosure via a communication line.

1. A cutting device comprising:
a cutting member; and
at least one processor that
receives an input of data in which an extended shape of a cutting line is set as a design, and
in response to the design in the data being an endless unicursal design that has a corner having an angle formed by two straight lines adjacent to one another being a predetermined angle or greater and in which at least one of the two straight lines forming the corner is a specific straight line having a length set to a predetermined length or greater, sets a position on the specific straight line at least the predetermined length away from the corner along the specific straight line as a press-contact start position of the cutting member and sets the corner as a press-contact end position of the cutting member to add at least the predetermined length to a length of one round of the cutting line for the cutting member to cut along the cutting line.

2. The cutting device according to claim 1,
wherein the cutting member is disposed to freely rotate on a predetermined axis, and
wherein the predetermined length corresponds to an offset distance from the predetermined axis to an edge of the cutting member.

3. The cutting device according to claim 1, wherein the at least one processor changes positions of a cutting target and the cutting member relative to one another with the cutting member pressed against the cutting target, thereby controlling the cutting member to cut the cutting target.

4. The cutting device according to claim 3, comprising:
a first drive mechanism that moves the cutting member in a first direction; and
a second drive mechanism that moves the cutting target in a second direction perpendicular to the first direction.

5. The cutting device according to claim 3,
wherein the cutting target is attached to a predetermined mount, and
wherein each of both ends of the mount is sandwiched between rollers of a roller pair.

6. The cutting device according to claim 5, wherein the mount is conveyed in a predetermined direction as the rollers rotate.

7. The cutting device according to claim 6, wherein the cutting member is moved in a direction perpendicular to the predetermined direction.

8. A cutting support method that is performed by a computer of a cutting device including a cutting member, the cutting support method comprising performing a control process of:
receiving an input of data in which an extended shape of a cutting line is set as a design; and
in response to the design in the data being an endless unicursal design that has a corner having an angle formed by two straight lines adjacent to one another being a predetermined angle or greater and in which at least one of the two straight lines forming the corner is a specific straight line having a length set to a predetermined length or greater, setting a position on the specific straight line at least the predetermined length away from the corner along the specific straight line as a press-contact start position of the cutting member and setting the corner as a press-contact end position of the cutting member to add at least the predetermined length to a length of one round of the cutting line for the cutting member to cut along the cutting line.

9. The cutting support method according to claim 8,
wherein the cutting member is disposed to freely rotate on a predetermined axis, and
wherein the predetermined length corresponds to an offset distance from the predetermined axis to an edge of the cutting member.

10. The cutting support method according to claim 8,
wherein the control process includes changing positions of a cutting target and the cutting member relative to one another with the cutting member pressed against the cutting target, thereby controlling the cutting member to cut the cutting target.

11. The cutting support method according to claim 10, wherein the cutting member cuts the cutting target, in which case the cutting member is moved in a first direction, and the cutting target is moved in a second direction perpendicular to the first direction.

12. The cutting support method according to claim 10, wherein the cutting member cuts the cutting target, in which case the cutting target is attached to a predetermined mount, and each of both ends of the mount is sandwiched between rollers of a roller pair.

13. The cutting support method according to claim 12, wherein the cutting member cuts the cutting target, in which case the mount is conveyed in a predetermined direction as the rollers rotate.

14. The cutting support method according to claim 13, wherein the cutting member cuts the cutting target, in which case the cutting member is moved in a direction perpendicular to the predetermined direction.

15. A non-transitory storage medium storing a program readable by a computer of a cutting device including a cutting member to cause the computer to perform a control process of:
receiving an input of data in which an extended shape of a cutting line is set as a design, and
in response to the design in the data being an endless unicursal design that has a corner having an angle formed by two straight lines adjacent to one another being a predetermined angle or greater and in which at least one of the two straight lines forming the corner is a specific straight line having a length set to a predetermined length or greater, setting a position on the specific straight line at least the predetermined length away from the corner along the specific straight line as a press-contact start position of the cutting member and setting the corner as a press-contact end position of the cutting member to add at least the predetermined length to a length of one round of the cutting line for the cutting member to cut along the cutting line.

16. The non-transitory storage medium according to claim 15,
wherein the cutting member is disposed to freely rotate on a predetermined axis, and
wherein the predetermined length corresponds to an offset distance from the predetermined axis to an edge of the cutting member.

17. The non-transitory storage medium according to claim 15, wherein the control process includes changing positions of a cutting target and the cutting member relative to one another with the cutting member pressed against the cutting target, thereby controlling the cutting member to cut the cutting target.

18. The non-transitory storage medium according to claim 17, wherein the cutting member cuts the cutting target, in which case the cutting member is moved in a first direction, and the cutting target is moved in a second direction perpendicular to the first direction.

19. The non-transitory storage medium according to claim 17, wherein the cutting member cuts the cutting target, in which case the cutting target is attached to a predetermined mount, and each of both ends of the mount is sandwiched between rollers of a roller pair.

20. The non-transitory storage medium according to claim 19, wherein the cutting member cuts the cutting target, in which case the mount is conveyed in a predetermined direction as the rollers rotate, and the cutting member is moved in a direction perpendicular to the predetermined direction.
